(19) United States
(12) Patent Application Publication
(10) Pub. No.: US 2017/0194882 A1
(43) Pub. Date: Jul. 6, 2017

(54) PLATFORM MOTOR DRIVING MODULE, PLATFORM CONTROLLING SYSTEM, AND PLATFORM SYSTEM

(71) Applicant: ZEROTECH (Chongqing) Intelligence Technology Co., Ltd., Chongqing (CN)

(72) Inventors: Xian-Wei Ren, Beijing (CN); Chao Wang, Beijing (CN); Xing-Qiang Pan, Beijing (CN)

(73) Assignee: ZEROTECH (Chongqing) Intelligence Technology Co., Ltd., Chongqing (CN)

(21) Appl. No.: 15/395,413

(22) Filed: Dec. 30, 2016

(30) Foreign Application Priority Data
Jan. 5, 2016 (CN) 201610006938.3
Jan. 5, 2016 (CN) 201620010275.8

(51) Int. Cl. H02P 5/00; G05B 1/01; H02P 27/08

(52) U.S. Cl. CPC H02P 5/00; H02P 27/08; G05B 1/01

(57) ABSTRACT

A platform motor driving module includes a platform main controller, a complex driving unit, and a plurality of motor driving feedback units each including a motor driver and a driving signal feedback circuit. The driving signal feedback circuit is electrically connected to the motor driver and the platform main controller, and is configured to send a feedback signal of the motor driver to the platform main controller. The complex driving unit is individually connected to the motor drivers of the plurality of motor driving feedback units and is configured to respectively provide driving controlling signals to the motor drivers. The platform main controller is electrically connected to the complex driving unit to control the complex driving unit to generate the driving controlling signals, and electrically connected to the driving signal feedback circuits to receive the feedback signals. A platform system and a platform controlling system are also disclosed.

### CROSS-REFERENCE TO RELATED APPLICATIONS

This application claims all benefits accruing under 35 U.S.C. §119 from Chinese Patent Applications No. 201610006938.3, filed on Jan. 5, 2016, and No. 201620010275.8, filed on Jan. 5, 2016, in the State Intellectual Property Office of China, the contents of all of which are hereby incorporated by reference.

### TECHNICAL FIELD

The present disclosure relates to platforms for carrying payloads, and particularly relates to platform motor driving modules, platform controlling systems, and platform systems.

### BACKGROUND

A vehicle may carry a payload through a platform to perform a task, such as aerial photography, surveillance, resource exploration, geological survey, and remote sensing. For example, an unmanned aerial vehicle may be equipped with a gimbal for carrying a camera. The platform can comprise three motors and three rotating members driven by the motors to rotate the payload about three axes, such as a pitch axis, a roll axis, and a yaw axis, to adjust an orientation of the payload (e.g., to adjust a shooting angle of a camera). The three motors are respectively driven by three motor drivers controlled by three controlling chips (e.g., microcontrollers) mounted on three circuit boards separately.

### BRIEF DESCRIPTION OF THE DRAWINGS

Implementations are described by way of example only with reference to the attached figures.

FIG. 1 is a block diagram of one embodiment of a platform motor driving module.

FIG. 2 is a block diagram of one embodiment of a driving signal feedback circuit.

FIG. 3 is a circuit diagram of one embodiment of a sampling circuit.

FIG. 4 is a circuit diagram of one embodiment of an amplifying circuit.

FIG. 5 is a block diagram of one embodiment of a platform system.

FIG. 6 is a block diagram of a portion of one embodiment of the platform system showing a connection between circuit elements.

FIG. 7 is a block diagram of one embodiment of the platform system in an application scenario.

FIG. 8 is a block diagram of a platform controlling system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

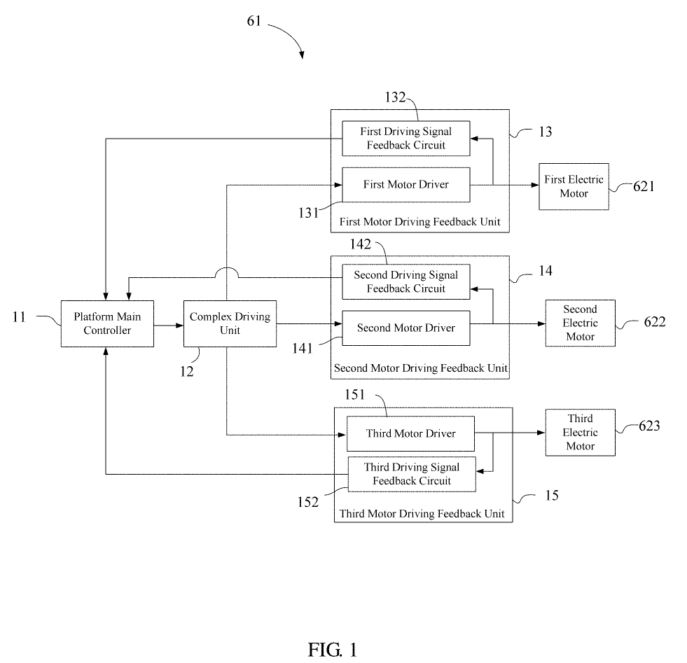

Referring to FIG. 1, one embodiment of a platform motor driving module 61 comprises a platform main controller 11, a complex driving unit 12, a first motor driving feedback unit 13, and a second motor driving feedback unit 14. The first motor driving feedback unit 13 comprises a first motor driver 131 and a first driving signal feedback circuit 132. The second motor driving feedback unit 14 comprises a second motor driver 141 and a second driving signal feedback circuit 142.

The complex driving unit 12 is individually electrically connected to the first and second motor drivers 131, 141 in the first motor driving feedback unit 13 and the second motor driving feedback unit 14, and is configured to respectively provide a first and a second driving controlling signals to the first and second motor drivers 131, 141.

The first and second motor drivers 131, 141 are configured to respectively receive the first and second driving controlling signals, and generate and apply motor drive signals to a first and a second electric motors 621, 622 according to the first and second driving controlling signals thereby independently driving the first and second electric motors 621, 622 to rotate.

The first driving signal feedback circuit 132 has one end electrically connected to the first motor driver 131 and another end electrically connected to the platform main controller 11. The first driving signal feedback circuit 132 is configured to send a feedback signal to feedback a working status of the first motor driver 131 to the platform main controller 11.

The second driving signal feedback circuit 142 has one end electrically connected to the second motor driver 141 and another end electrically connected to the platform main controller 11. The second driving signal feedback circuit 142 is configured to send a feedback signal to feedback a working status of the second motor driver 141 to the platform main controller 11.

The platform main controller 11 is electrically connected to the complex driving unit 12 to control the complex driving unit 12 to generate the driving controlling signals. The platform main controller 11 is also electrically connected to the first and second driving signal feedback circuits 132, 142 to receive feedback signals.

In one embodiment, the platform motor driving module 1 further comprises a third motor driving feedback unit 15. The third motor driving feedback unit 15 comprises a third motor driver 151 and a third driving signal feedback circuit 152. The complex driving unit 12 is respectively electrically connected to the first, second, and third motor drivers 131, 141, 151, and is configured to respectively provide a first, second, and third driving controlling signals to the first, second, and third motor drivers 131, 141. The third motor driver 151 is configured to receive the third driving controlling signal, and apply a motor drive signal to a third electric motors 623 according to the third driving controlling signal thereby independently driving the third electric motors 623 to rotate. The third driving signal feedback circuit 152 has one end electrically connected to the third motor driver 151 and another end electrically connected to the platform main controller 11. The third driving signal feedback circuit 152 is configured to send a feedback signal to feedback a working status of the third motor driver 151 to the platform main controller 11. The platform main controller 11 is electrically connected to the third driving signal feedback circuits 152 to receive the feedback signal.

The complex driving unit 12 can respectively provide the driving controlling signals to the motor drivers thereby controlling the motor drivers at the same time. In one embodiment, the complex driving unit 12 can comprise a central controlling chip that is configured to generate a plurality of channels of pulse width modulation (PWM) signals as the driving controlling signals. Each of the first, second, and third driving controlling signals can comprise three channels of PWM signals. The complex driving unit 12 can comprise three output ends for respectively outputting the three channels of PWM signals to one motor driver. Each motor driver can comprise three input ends electrically connected to the three output ends for receiving the three channels of PWM signals in a one-to-one manner. The central controlling chip is capable of generating a plurality of channels of PWM signals, such as MB15030 chip, a microprocessor control unit (MCU) chip, or a field-programmable gate array (FPGA) chip. The complex driving unit 12 can be electrically connected to the motor drivers through flexible printed circuit (FPC).

In one embodiment, the complex driving unit 12 comprises six output ends, three of which are electrically connected to the three input ends of the first motor driver 131 for transmitting the three PWM signals as the first driving controlling signals, and the other three of which are electrically connected to the three input ends of the second motor driver 141 for transmitting the three PWM signals as the second driving controlling signals.

In another embodiment, the complex driving unit 12 comprises nine output ends, three of which are electrically connected to the three input ends of the third motor driver 151 for transmitting the three PWM signals as the third driving controlling signals.

The complex driving unit 12 can be separate from the motor drivers and integrated with the platform main controller 11. In one embodiment, the complex driving unit 12 and the platform main controller 11 are mounted on the same circuit board. In another embodiment, the complex driving unit 12 and the platform main controller 11 are mounted on different circuit boards and electrically connected by the FPC.

The present disclosure integrates and centralizes the controlling of the three motor drivers from the three separate controlling chips into one complex driving unit 12, which decreases the number of chips and corresponding circuit boards to be mounted in the platform system, thereby decreasing the amount and area of the circuit boards and reducing the cost.

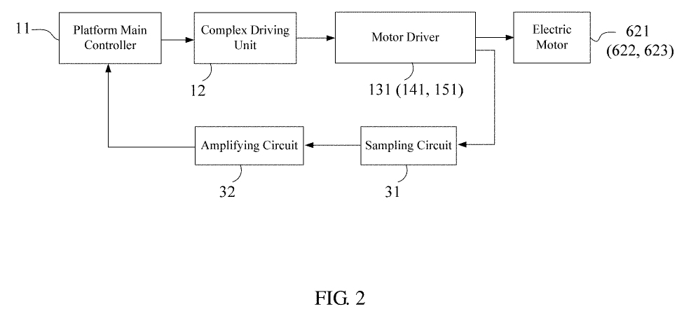

Referring to FIG. 2, each of the first, second, and third driving signal feedback circuits 132, 142, 152 comprises a sampling circuit 31 and an amplifying circuit 32. The sampling circuit 31 is electrically connected to the corresponding motor driver (e.g., the first, second, or third motor driver 131, 141, 151), and configured to receive a sampling voltage at an output end of the motor driver. In one embodiment, each motor driver comprises three output ends for applying three motor drive signals to the corresponding electric motor. The sampling circuit 31 is configured to receive the sampling voltage at the three output ends of the motor driver.

The amplifying circuit 32 having one end electrically connected to the sampling circuit 31 and another end electrically connected to the platform main controller 11. The amplifying circuit 32 is configured to amplify the sampling voltage and output the amplified sampling voltage, which is the feedback signal, to the platform main controller 11.

The platform main controller 11 receives real-time values of the three motor drive signals output from the motor driver to implement a closed-loop control. Each of the first, second, and third driving signal feedback circuits 132, 142, 152 having the sampling circuit 31 and the amplifying circuit 32 is capable of sampling and amplifying the three sampling voltage and feeding the amplified sampling voltage back to the platform main controller 11.

In one embodiment, the sampling circuit 31 comprises sampling resistances, and the amplifying circuit 32 comprises amplifiers.

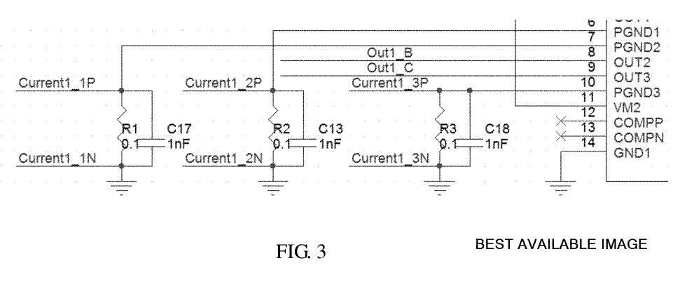

Referring to FIG. 3, one embodiment of the sampling circuit 31 comprises a first sampling resistor R1, a second sampling resistor R2, a third sampling resistor R3, a first capacitor C17, a second capacitor C13, and a third capacitor C18.

A first terminal of the first sampling resistor R1 is electrically connected to a first protect ground terminal PGND1 of the motor driver and the first terminal of the first capacitor C17. The second terminal of the first sampling resistor R1 is electrically connected to the second terminal of the first capacitor C17 and a common ground terminal.

A first terminal of the second sampling resistor R2 is electrically connected to the second protect ground terminal PGND2 of the motor driver and the first terminal of the second capacitor C13. The second terminal of the second sampling resistor R2 is electrically connected to the second terminal of the second capacitor C13 and a common ground terminal.

A first terminal of the third sampling resistor R3 is electrically connected to the third protect ground terminal PGND3 of the motor driver and the first terminal of the third capacitor C18. The second terminal of the third sampling resistor R3 is electrically connected to the second terminal of the third capacitor C18 and a common ground terminal.

In one embodiment, the resistance value of each of the first sampling resistor R1, the second sampling resistor R2, and the third sampling resistor R3 is 0.1 Ω. The capacitance value of each of the first capacitor C17, the second capacitor C13, and the third capacitor C18 is 1 nF.

The motor driver can comprise a commercially available motor driver IC. The signals output from the first protect ground terminal PGND1, the second protect ground terminal PGND2 and the third protect ground terminal PGND3 of the motor driver IC are the three sampling voltage corresponding to the three channels of motor drive signals of the motor driver. By connecting the sampling resistors to the PGND1, the PGND2, and the PGND3, a voltage difference corresponding to the sampling voltage can be obtained between the two terminals of the sampling resistor. The two terminals of the first sampling resistor R1, the second sampling resistor R2, and the third sampling resistor R3 can be respectively electrically connected to the amplifying circuit 32 to form the feedback signals for the platform main controller 11. As shown in FIG. 3, the terminals Current1_1P and terminal Current1_1N of the first sampling resistor R1, the terminals Current1_2P and terminal Current1_2N of the second sampling resistor R2, and the terminals Current1_3P and terminal Current1_3N of the third sampling resistor R3 are respectively electrically connected to the amplifying circuit 32.

It should be noted that, since the three channels of the sampling voltage corresponding to the three channels of motor driving signals of the motor driver IC can form a triangle, theoretically, the platform main controller 11 only needs to obtain the amplified signal of two sampling voltages, and the amplified signal of the third sampling voltage can be calculated according to the cosine theorem.

In one embodiment, the amplifying circuit 32 can comprise a first amplifier and a second amplifier.

A first input terminal of the first amplifier can be electrically connected to a first terminal Current1_1P of the first sampling resistor R1. A second input terminal of the first amplifier can be electrically connected to a second terminal Current1_1N of the first sampling resistor R1. An output end of the first amplifier can be electrically connected with a first analog-to-digital conversion (ADC) input terminal of the platform main controller 11.

A first input terminal of the second amplifier can be electrically connected to a first terminal Current1_2P of the second sampling resistor R2. A second input terminal of the second amplifier can be electrically connected to a second terminal Current1_1N of the second sampling resistor R2. An output end of the second amplifier can be electrically connected with a second analog-to-digital converter (ADC) input terminal of the platform main controller 11.

The first and second amplifiers can be integrated into a dual operational amplifier chip (dual op-amp IC) with a matching circuit. The matching circuit is coupled to specified pins of the dual op-amp IC for configuring the amplification of the first amplifier and the second amplifier. The matching circuit comprises at least two resistors and at least two capacitors.

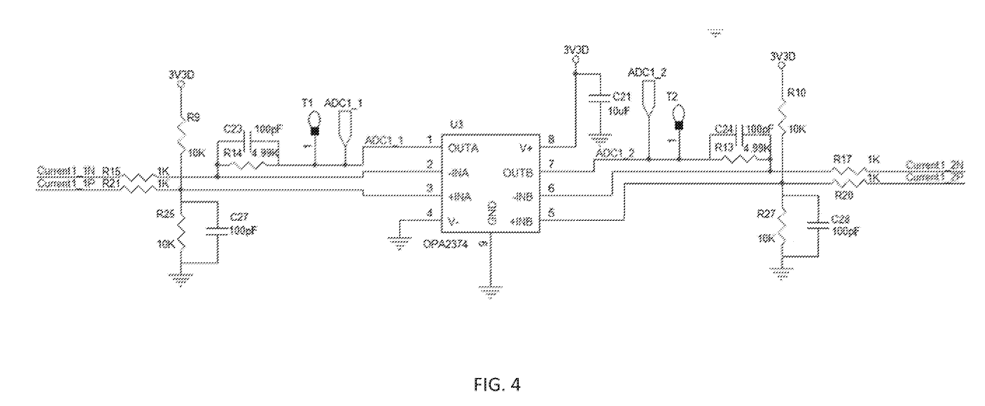

Referring to FIG. 4, one embodiment of the amplifying circuit 32 comprises the dual op-amp IC OPA2374 to realize the function of the first and second amplifiers. The matching circuit comprising capacitor C23, resistor R14, capacitor C27, and resistor R25 can achieve a 5 times of amplification in the first amplifier. The matching circuit comprising capacitor C24, resistor R13, capacitor C28, and resistor R27 can achieve a 5 times of amplification in the second amplifier.

In use, after the electric motor driven by the corresponding motor driver works normally, the back flow voltage signal is obtained by sampling and amplifying the voltage difference formed on the sampling resistance, and a 5-time amplification of the voltage difference is input to the ADC of the platform main controller 11. A phase difference between the motor drive current and the three channels of the motor drive signals can be calculated to achieve the real-time closed-loop control.

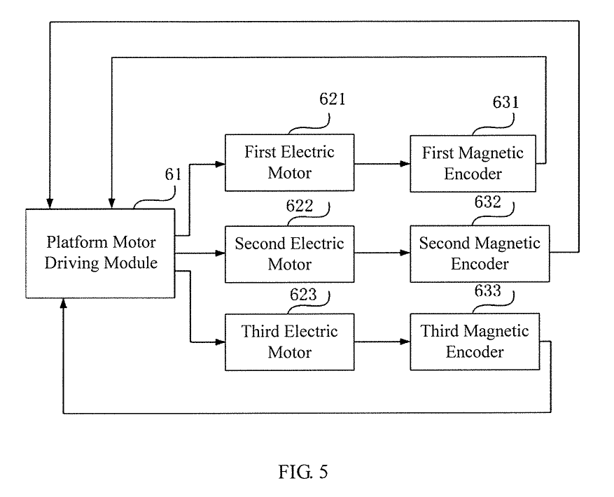

Referring to FIG. 5, one embodiment of a platform system comprises the platform motor driving module 61, the first electric motor 621 coupled to the first motor driver 131, the second electric motor 622 coupled to the second motor driver 141, the third electric motor 623 coupled to the third motor driver 151. The platform system can further comprise a first magnetic encoder 631, a second magnetic encoder 632, and a third magnetic encoder 633 configured to sense a rotational degree between a rotor and a stator in the first, second, and third electric motors 621, 622, 623. The first, second, and third magnetic encoders 631, 632, 633 each has one end electrically connected to the platform main controller 11 and another end electrically connected to the corresponding first, second, and third electric motors 621, 622, 623 in a one-to-one manner. The platform motor driving module 61 can be a dual core processor, which integrate two processing units into one processer. The dual core processor can comprise a plurality of output terminals to generate a plurality of channels of PWM signals. The first, second, and third electric motors 621, 622, 623 can be accessed through an II2C interface.

For convenience of description, the connection in the platform system is described by using only one group of motor driving feedback unit and electric motor (e.g., one motor drive, one driving signal feedback circuit, one electric motor, and one magnetic encoder) as an example. It is understandable that the three groups of motor driving feedback unit and electric motor have the same structure, connection manner, and working principle.

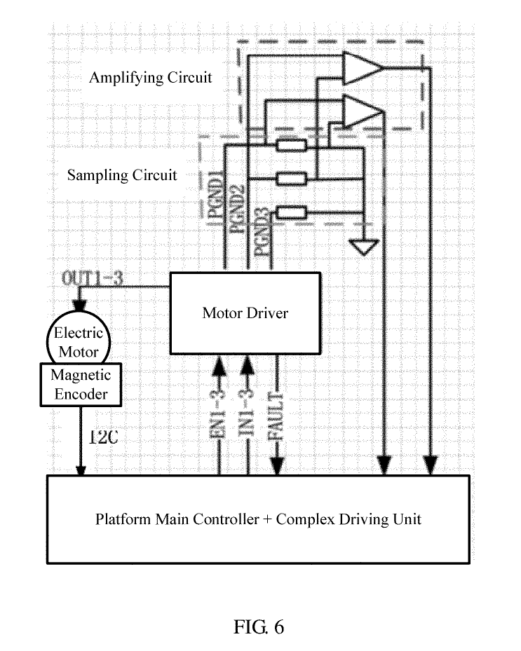

Referring to FIG. 6, the complex driving unit 12 is configured to transmit three channels of driving controlling signals IN1-3 and three channels of enable signals EN1-3 to the motor driver. The motor driver is configured to generate three channels of motor drive signals OUT1-3 corresponding to the IN1-3 and EN 1-3 to drive the electric motor. The sampling circuit 31 is configured to sample the sampling voltage output from the terminals PGND1, PGND2, and PGND3. The amplifying circuit 32 is configured to amplify two of the three channels of sampling voltage and feed the amplified signals back to the platform main controller 11, thereby achieving the closed-loop control to the electric motor.

The magnetic encoder generates an encode signal based on a rotation speed of the electric motor, which reflects the working status of the electric motor, and transmits the encode signal to the platform main controller 11 through the bus I2C. The platform main controller 11 is configured to control and adjust the driving and controlling signal output from the complex driving unit 12 based on the working status of the electric motor.

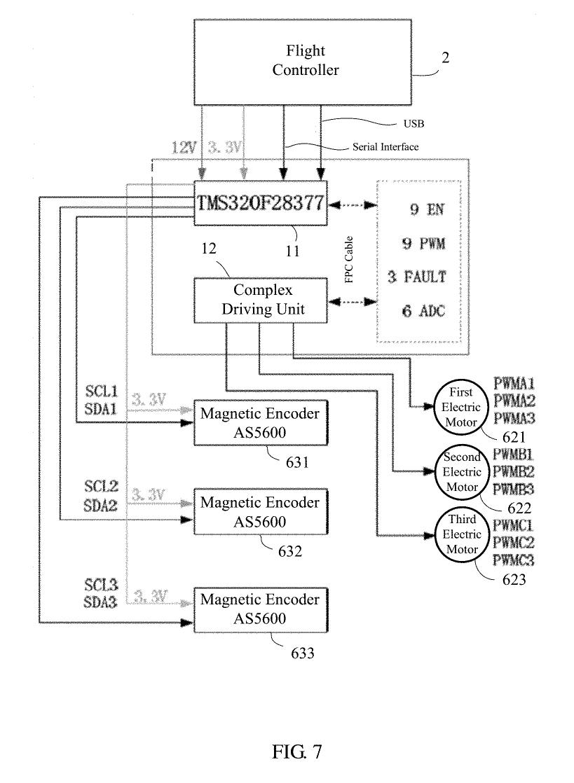

Referring to FIG. 7, in one specific application, the platform main controller 11 comprises a microprocessor control unit, such as TMS320F28377, as a processor, and the magnetic encoder comprises a chip such as AS5600. The platform main controller 11 can comprise a communication interface, such as a serial interface and a universal serial bus (USB) interface, for communicating with a flight controller 2.

As shown in FIG. 7, by using the complex driving unit 12, which is independent from the three motor drivers and integrated in the platform system, the power supply system of the platform system can be simplified by having only two power supplies.

Conventionally, the motor drivers are mounted on separate driving boards, each of which has a controlling chip connected to the platform main controller via a controller area network (CAN), and the platform main controller is uplinked to the flight controller via the CAN. In the present disclosure, the feedback signals obtained by the complex driving unit 12 can be directly transmitted to the platform main controller 11, which can communicate with the flight controller directly through the serial interface or the USB interface, sending and receiving can be accomplished in two ways, the controlling is centralized, the driver for CAN is eliminated, and the circuit area is decreased. The connection in the platform system is simplified to improve the reliability of the platform system.

In one embodiment, the platform system, such as a gimbal system, further comprises support members configured to carry and rotate a payload. The support member, which can be a support arm, is configured to directly or indirectly couple with and support the payload. The electric motors are configured to drive the corresponding support members thereby rotating the support members about or around multiple axes in a one-to-one manner. The support members driven by the electric motors rotate about or around the multiple axes, and the payload coupled to the support members rotates with the support members.

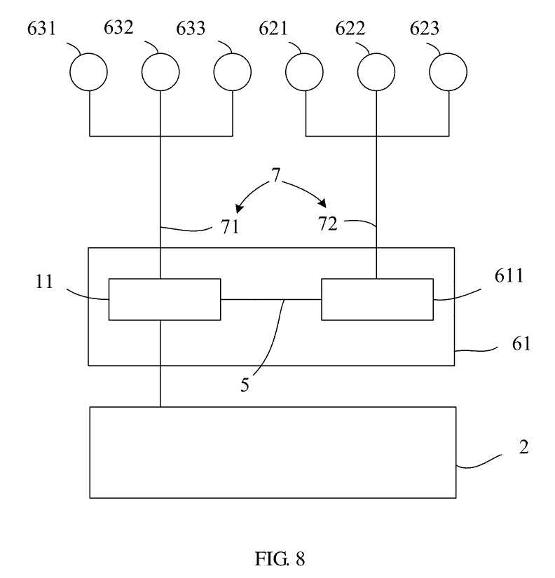

Referring to FIG. 8, one embodiment of a platform controlling system comprises the platform motor driving module 61 and a flight controller 2. The platform motor driving module 61 can comprise the platform main controller 11 and a motor driving controller 611. The platform main controller 11 is electrically connected to the flight controller 2. The motor driving controller 611 comprise the complex driving unit 12 and the motor driving feedback units (e.g., the first, second, and third motor driving feedback units 13, 14, 15). The platform main controller 11 is electrically connected to the motor driving controller 611, and electrically connected to the magnetic encoders 631, 632, 633 respectively. The motor driving controller 611 is electrically connected to the electric motors 621, 622, 623.

The platform main controller 11 can be electrically connected to the motor driving controller 611 through a first flexible printed circuit (FPC) 5. The platform controlling system can further comprise a second FPC 7 having the magnetic encoder signal wires 71 and the motor drive signal wires 72 integrated therein. A power supply to the platform main controller 11 can have a voltage of about 3.3 V. A power supply to the motor driving controller 611 can have a voltage of about 12 V.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A platform motor driving module comprising:
a platform main controller;
a complex driving unit; and
a plurality of motor driving feedback units, each of the plurality of motor driving feedback units comprising a motor driver and a driving signal feedback circuit, the driving signal feedback circuit being electrically connected to the motor driver and the platform main controller, and being configured to send a feedback signal of the motor driver to the platform main controller;
wherein the complex driving unit is individually and electrically connected to the motor drivers of the plurality of motor driving feedback units and is configured to respectively provide driving controlling signals to the motor drivers; each of the motor drivers is configured to respectively receive one of the driving controlling signals, the motor drivers respectively generate motor drive signals according to the driving controlling signals thereby independently driving a plurality of electric motors; the platform main controller is electrically connected to the complex driving unit to control the complex driving unit to generate the driving controlling signals.

2. The platform motor driving module of claim 1, wherein the complex driving unit comprises a central controlling chip configured to generate a plurality of channels of pulse width modulation signals as the driving controlling signals, each of the driving controlling signals comprising three channels of pulse width modulation signals.

3. The platform motor driving module of claim 1, wherein the driving signal feedback circuit comprises a sampling circuit and an amplifying circuit, the sampling circuit is electrically connected to the motor driver and is configured to receive sampling voltage of the motor driver, the amplifying circuit is electrically connected to the sampling circuit and the platform main controller, and the amplifying circuit is configured to amplify the sampling voltage and output the amplified sampling voltage to the platform main controller.

4. The platform motor driving module of claim 3, wherein the sampling circuit comprises a first sampling resistor, a second sampling resistor, a third sampling resistor, a first capacitor, a second capacitor, and a third capacitor; a first terminal of the first sampling resistor is connected to a first protect ground terminal of the motor driver and the first terminal of the first capacitor, the second terminal of the first sampling resistor is connected to the second terminal of the first capacitor and a common ground terminal; a first terminal of the second sampling resistor is connected to the second protect ground terminal of the motor driver and the first terminal of the second capacitor, the second terminal of the second sampling resistor is connected to the second terminal of the second capacitor and the common ground terminal; a first terminal of the third sampling resistor is connected to the third protect ground terminal of the motor driver and the first terminal of the third capacitor, the second terminal of the third sampling resistor is connected to the second terminal of the third capacitor and the common ground terminal.

5. The platform motor driving module of claim 4, wherein the amplifying circuit comprises a first amplifier and a second amplifier; a first input terminal of the first amplifier is connected to a first terminal of the first sampling resistor, a second input terminal of the first amplifier is connected to a second terminal of the first sampling resistor, an output end of the first amplifier is connected with a first analog-to-digital conversion input terminal of the platform main controller; a first input terminal of the second amplifier is connected to a first terminal of the second sampling resistor, a second input terminal of the second amplifier is connected to a second terminal of the second sampling resistor, an output end of the second amplifier is connected with a second analog-to-digital converter input terminal of the platform main controller.

6. The platform motor driving module of claim 5, wherein the first amplifier and the second amplifier are integrated into a dual operational amplifier chip with a matching circuit, the matching circuit is coupled to specified pins of the dual op-amp IC for configuring the amplification of the first amplifier and the second amplifier, the matching circuit comprises at least two resistors and at least two capacitors.

7. The platform motor driving module of claim 1, wherein the complex driving unit is electrically connected to the motor drivers through a flexible printed circuit.

8. The platform motor driving module of claim 1, wherein the complex driving unit and the platform main controller are connected by another flexible printed circuit.

9. The platform motor driving module of claim 1, wherein the platform main controller comprises at least one communication interface, and the at least one communication interface is a serial interface or a universal serial bus interface.

10. The platform motor driving module of claim 1, wherein the plurality of motor driving feedback units is two motor driving feedback units, and the plurality of electric motors is two electric motors.

11. The platform motor driving module of claim 1, wherein the plurality of motor driving feedback units is three motor driving feedback units, and the plurality of electric motors is three electric motors.

12. A platform system comprising:
a platform motor driving module comprising a platform main controller, a complex driving unit, and a plurality of motor driving feedback units, each of the plurality of motor driving feedback units comprising a motor driver and a driving signal feedback circuit, the driving signal feedback circuit being electrically connected to the motor driver and the platform main controller, and being configured to send a feedback signal of the motor driver to the platform main controller;
a plurality of electric motors respectively coupled to the motor drivers; and
a plurality of magnetic encoders, each of the plurality of magnetic encoders being electrically connected to the platform main controller and one electric motor;
wherein the complex driving unit is individually and electrically connected to the motor drivers of the plurality of motor driving feedback units and is configured to respectively provide driving controlling signals to the motor drivers; each of the motor drivers is configured to respectively receive one of the driving controlling signals, and the motor drivers respectively generate motor drive signals according to the driving controlling signals thereby independently driving the plurality of electric motors; the platform main controller is electrically connected to the complex driving unit to control the complex driving unit to generate the driving controlling signals, and the platform main controller is also electrically connected to the driving signal feedback circuits to receive the feedback signals.

13. The platform system of claim 12, wherein the plurality of motor driving feedback units is two motor driving feedback units, the plurality of electric motors is two electric motors, and the plurality of magnetic encoders is two magnetic encoders.

14. The platform system of claim 12, wherein the plurality of motor driving feedback units is three motor driving feedback units, the plurality of electric motors is three electric motors, and the plurality of magnetic encoders is three magnetic encoders.

15. The platform system of claim 12, wherein the complex driving unit is electrically connected to the motor drivers through a flexible printed circuit.

16. The platform system of claim 12, wherein the complex driving unit and the platform main controller are electrically connected by another flexible printed circuit.

17. The platform system of claim 12 further comprising a plurality of support members respectively driven by the plurality of electric motors in a one-to-one manner to rotate.

18. A platform controlling system comprising:
a platform motor driving module comprising a platform main controller, a complex driving unit, and a plurality of motor driving feedback units, each of the plurality of motor driving feedback units comprising a motor driver and a driving signal feedback circuit, the driving signal feedback circuit being electrically connected to the motor driver and the platform main controller, and being configured to send a feedback signal of the motor driver to the platform main controller; and
a flight controller electrically connected to the platform main controller;
wherein the complex driving unit is individually and electrically connected to the motor drivers of the plurality of motor driving feedback units and is configured to respectively provide driving controlling signals to the motor drivers; each of the motor drivers is configured to respectively receive one of the driving controlling signals, the motor drivers respectively generate motor drive signals according to the driving controlling signals thereby independently driving the plurality of electric motors; the platform main controller is electrically connected to the complex driving unit to control the complex driving unit to generate the driving controlling signals.

19. The platform controlling system of claim 18, wherein the plurality of motor driving feedback units is two motor driving feedback units, and the plurality of electric motors is two electric motors.

20. The platform controlling system of claim 18, wherein the plurality of motor driving feedback units is three motor driving feedback units, and the plurality of electric motors is three electric motors.
